(19) United States
(12) Patent Application Publication
(10) Pub. No.: US 2008/0001001 A1
(43) Pub. Date: Jan. 3, 2008

(54) Pneumatic Activated Fountain

(76) Inventor: Stephen H. Pevnick, Milwaukee, WI (US)

Correspondence Address: WHYTE HIRSCHBOECK DUDEK S C, 555 EAST WELLS STREET, SUITE 1900, MILWAUKEE, WI, 53202, US

(21) Appl. No.: 11/736,241

(22) Filed: Apr. 17, 2007

Related U.S. Application Data
(60) Provisional application No. 60/744,988, filed on Apr. 17, 2006.

(51) Int. Cl. B05B 17/08

(52) U.S. Cl. 239/23

(57) ABSTRACT

Droplet formation in a graphic waterfall fountain is pneumatically controlled. Improvements in the delivery of the water droplets can be obtained by pressurizing the fountain manifold. The fountain can be soundproofed by isolating the solenoid assembly with soundproofing materials or by submersion in water.

### CROSS-REFERENCE TO RELATED APPLICATION

This Application claims priority from Provisional U.S. Application No. 60/744,988, filed on Apr. 17, 2006.

### BACKGROUND OF THE INVENTION

The present invention relates to a gravity flow fountain and, more particularly to a method of, and apparatus for, actuating and controlling the valve operation of a gravity flow fountain.

Gravity flow fountains of various designs and configurations can generate a display comprising a cascade of water droplets. These water droplets, when grouped together and properly synchronized, assume or compose various shapes, images, and/or messages. The shape and resolution of the images is controlled by selectively opening and closing numerous small holes in a bottom of a fluid filled manifold. The holes are opened and closed by the retraction and insertion, respectively, of needle-shaped plugs into the hole. The movement of the needle plugs is driven by solenoids. Typically, for ease of construction, multiple needle plugs will be controlled as an array.

### BRIEF SUMMARY OF THE INVENTION

In one embodiment, the invention is a free falling water droplet fountain comprising a manifold having a series of openings, at least one control assembly for independently controlling the size and rate of release of water droplets from the openings, the controlling assembly including a plurality of pneumatically actuated valve assemblies for defining the form and size of the water droplets.

In another embodiment, the invention is a system for controlling droplet formation in a fountain, the system comprising: at least one pneumatic solenoid valve in fluid communication with a source of pressurized air; at least one manifold having a series of openings; at least one control assembly for independently controlling the size and rate of release of water droplets from the openings, the controlling assembly including a plurality of pneumatically actuated valve assemblies for defining the form and size of the water droplets, wherein the valve assemblies are controlled between an open position and a closed position by selective actuation of the pneumatic solenoid.

### BRIEF DESCRIPTION OF THE DRAWINGS

FIG. 1 is a schematic view of the pneumatically activated fountain.

FIG. 2 is a side cross-sectional view of the valve piston assembly.

FIG. 2A is a side view of electric-solenoid valve assembly.

FIG. 3 is a schematic view of the fountain waterfall.

FIGS. 4A and 4B are schematic top oblique and side cross-sectional views of the waterfall module.

FIGS. 5A and 5B are schematic top oblique and side views of a sound enclosure.

FIGS. 6A-D show schematic views of modular sound enclosures.

FIG. 7 shows a schematic view of a sound curtain.

FIG. 8 shows a schematic view of an embodiment where the module is submerged under water.

### DETAILED DESCRIPTION OF THE INVENTION

In general, gravity flow fountains capable of generating these displays are known in the art. By way of example, U.S. Pat. No. 4,294,406 to Pevnick discloses a program controllable free falling water drop fountain and U.S. Pat. No. 6,196,471 to Ruthenberg discloses an apparatus for providing a waterfall or fountain capable of making displays formed from water droplets. Further, U.S. Pat. No. 6,053,423 to Jacobsen, U.S. Pat. No. 5,524,822 to Simmons, and U.S. Pat. No. RE35,866 to Simmons teach methods of producing fountain images and displays using nozzles or timely released, gravity-affected droplets. Additionally, U.S. Pat. No. 5,737,860 to Whigham discloses a method and apparatus employing gravity to display a message. Also, U.S. Pat. No. 6,557,777 to Pevnick discloses a water supply method and apparatus for a gravity fountain. All of these U.S. patents are incorporated herein by reference.

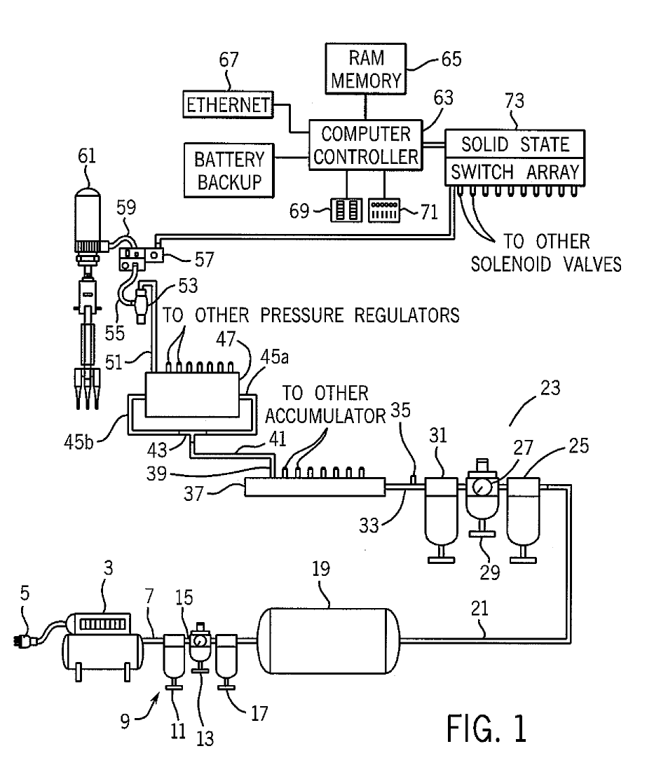

FIG. 1 shows a schematic view of the pneumatically activated fountain of this invention. The air drive system 1 comprises an air compressor 3, which is connected to an electrical source 5. Air compressor 3 provides a source of compressed air, typically at a pressure between about 125 to about 150 psi. The compressed air travels through a conduit 7 to a first pressure regulator/oiler 9.

Pressure regulator/oiler 9 comprises an air filter 11, a regulator valve 13, a pressure gauge 15, and an oiler 17. First pressure regulator/oiler 9 functions to both reduce the pressure and to reduce fluctuations in the air pressure. Typically, the air pressure can be between about 100 to about 150 psi exiting the first regulator/oiler 9.

A main accumulator 19 is provided after the first pressure regulator/oiler 9 to provide a buffer for compressed air. This buffer acts to help smooth out pressure fluctuations from the compressor. Compressed air from the accumulator passes through conduit 21 to a second pressure regulator/oiler 23.

The second regulator/oiler 23 comprises an oiler 25, a pressure gauge 27, a pressure regulator valve 29, and a filter 31. The second pressure regulator/oiler 23 further reduces the pressure, in this example to about 75 psi.

The compressed air from the second pressure regulator/oiler 23 is split out to each individual control module by the first flow divider 35. In this view, only one module is shown, but other modules may be added as desired. Compressed air from the first flow divider 35 passes through conduit 33 to an air branch manifold 37.

Air branch manifold 37 has a number of taps 39. Compressed air flows from a tap 39 through a conduit 41 to a second flow divider 43. Flow divider 43 splits the flow between conduits 45a and 45b which each feed opposite ends of branch accumulator 47. Although not shown in detail here, each of the other taps 39 of air branch 37 will feed a separate branch accumulator 47. Feeding both ends of accumulator 47 prevents dead spots of low pressure within the accumulator and has been found to be able to provide each of taps 49 with essentially the same air pressure (pressure differentials of 0.25 psi or less).

Compressed air from the branch accumulator 47 flows through a conduit 51 attached to an accumulator tap 49 to a pressure regulator 53. Again, although not shown, each tap 49 will provide air to a separate line 51 feeding a separate pressure regulator 53. Pressure regulator 53 is preset and, therefore, does not require a gauge, although a gauge may be placed at this position if desired. The regulated air from pressure regulator 53 passes through conduit 55 to a pneumatic solenoid valve 57.

Pneumatic solenoid valve 57 drives piston 61 via conduit 59. The operation of solenoid valve 57 is driven by computer controller 63. Computer controller 63 operates a program stored on either memory 65 or obtained through the ethernet 67. The program is designed to control the timing and movement of the pistons 61 so as to make desired graphical image. Output from the computer controller 63 is sent to each solenoid valve 57 via a solid state switch array 73.

One embodiment of the air piston has a spring return. The spring is inside the air cavity or part of the current mechanical commercially available air piston. There is an electronically controlled air valve that governs the air piston. In another embodiment, the electronically controlled air valve 57 can switch the direction of the air flow so that the air piston 61 closed with air pressure as well as opens with air pressure. The speed of air closing might also be on a second regulator per air piston, but only as an option. The primary air closing would be on the existing air regulator.

A programmed sequential release of water droplets from the manifold is accomplished by the use of a computer which is connected to the trigger circuit as is generally understood in the art. The computer includes a parallel interface to provide a digital machine language word which is interpreted by a decoder. The decoder selects the proper timers in the array of valve assemblies. The timer then opens the power transistor to energize the coil to open the valve assembly. The timers are preset to a controlled time period to close the valve when the proper amount of water has been provided to release the water droplet and concurrently load another hanging droplet ready to fall.

The computer can be any conventional computer which will provide memory registers for certain calculated data. This data can be in the form of index, row, column, interval between droplets, interrupt and strobe information. Programs can be preprogrammed or various source information can be used to activate the computer to produce the desired image. Source information may be based on the galvanic skin resistance or position of the viewer in respect to the fountain. The computer can also be used to generate electronic sound or control a tape trigging mechanism to play music. As an example the computer can sense the sunrise to turn lights off and darkness to turn lights on; preprogrammed computer color light laser display; and wind speed alter program or shutdown. The programs could be the solid memory punch tape or any of the various program sources which are available. It is also possible to program the manifold to play percussive rhythmic music with the falling water droplets acting as individual sound generation elements falling on water or on the solid base.

All conduits may be made of any suitable pipes or tubing. Conveniently, the conduits are made of plastic tubing having sufficient strength to contain the compressed air.

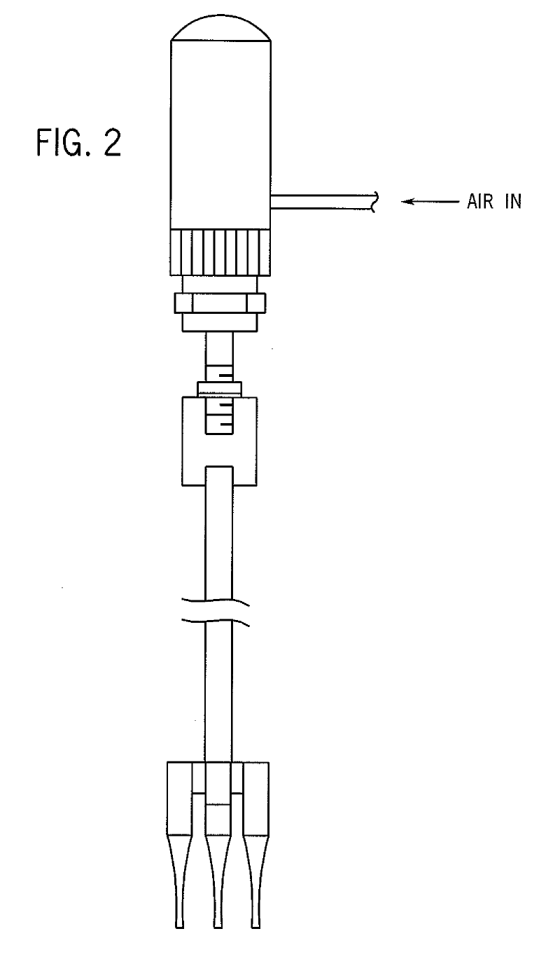

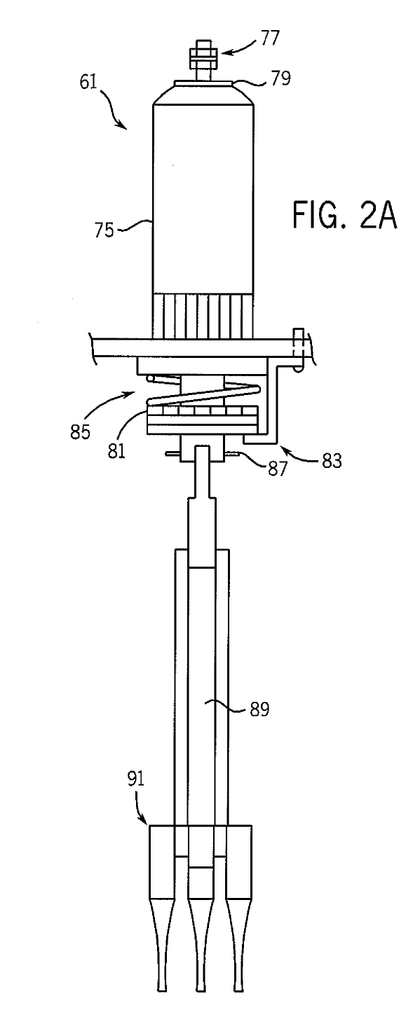

FIG. 2 shows a more detailed view of piston 61. This piston 61 is useable both for the air activated system of this invention and for more conventional electrically activated pistons. In FIG. 2A, solenoid 75 provides on and optional off power to the piston 67. Typically, solenoid 75 may be encased with a metal jacket enclosure.

For either air solenoids or electric solenoids, adjustment means 77, shown here as two locking nuts and lock washer, allow for accurate positioning of piston 61 in relation to the valve holds. A sound-absorbing washer 79 may be mounted on top of solenoid 75 as part of the sound abatement system. Pad 81 mounted under the solenoid 75 along the piston shaft helps absorb the shock of the piston 61 moving up and down. Optionally, bracket 83 stops or limits the down closing motion of the piston. Spring 85 drives the piston 61 to a return position when the solenoid 75 is not activated. Roll pin 87, which may also be a springpin, provides means for connecting lower shaft 89 to the solenoid 75. This allows for replacement shafts being mounted to the solenoid. Lower shaft 89 may comprise a hollow tube of resin and fiberglass or carbon fiber. Preferably, lower shaft 89 is made as light as possible to reduce the load on the solenoid 75. A comb pintle 91 is located at the bottom of lower shaft 89 and comprises an array of pintle plugs. These pintle plugs provide positive closure of the valve openings. Opening and closing the valves with the pintle plugs reduces the droplets that form the graphical image.

In one embodiment, the adjustment of the connecting rod between the air piston and the 9 needle valve is done with a screw turning motion. The air piston has a metal threaded rod protruding from its base. A plastic adaptor is threaded with a female thread and has a vertically slotted shape that has a hole for a spring pin. The tongue for the slot is on the connecting rod to the nine needle part that forms the opening and closing part of the valve.

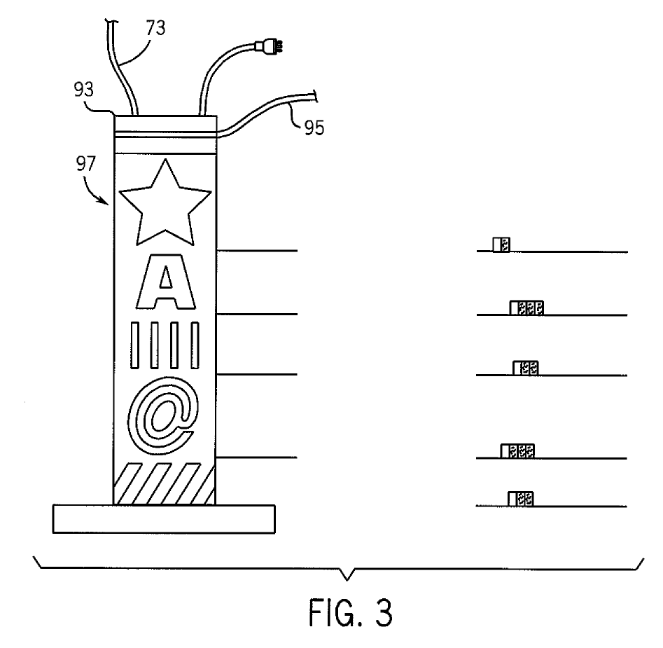

The pneumatically operated piston 61 is can be incorporated into the manifolds of a vertical graphical waterfall as is known in the art. Typical such known waterfalls are disclosed in U.S. Pat. Nos. 4,294,406 and 6,557,777, incorporated herein and by reference. As shown in FIG. 3, a water manifold having multiple piston 61 is provided with water or other suitable fluid through an intake 95. The movement of piston 61 is driven to communication link 73 as discussed for FIG. 1. The vertical movement of piston 61 opens and closes nozzle values in the bottom of manifold 93. When the nozzle value is open, a stream of water is discharged through the nozzle and falls vertically. The accumulated affects of the opening and closing of the nozzles results in graphical images 97. The resolution of the graphic can be controlled by the delay in closing the value nozzle. A longer open time falling in open signal and electrical/mechanic action of piston 61 makes a thicker cluster of water droplets in freefall. It is desirable to be able to adjust this delay after on signal to put back the close time of the value depending on the overall resolving power needed. Course and fine resolutions, and variations in between, are assigned to each graphic of a symbol or kinetic pattern as shown in FIG. 3.

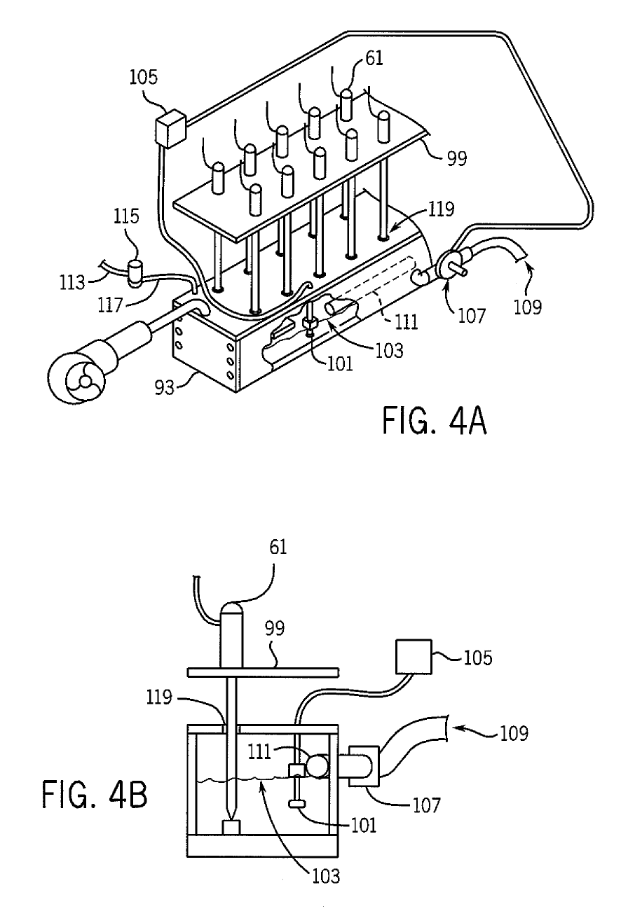

Another factor that influences the quality of the graphic image is the pressure head above the nozzle when the value is opened. Typically, this pressure head is determined by the height of the water in the reservoir of manifold 93. The height of the water in the reservoir can be controlled in numerous ways as disclosed in U.S. Pat. No. 6,557,777. In an optional embodiment shown in FIGS. 4A and B, the pressure head of the fluid level is augmented by an overpressure of air within manifold 93. The overpressure provided by the air minimizes any differences in local pressures due to local variations and fluid height.

As shown, an array of electric solenoids or air piston 61 is mounted to a mounting plate 99. Piston 61 extends from the mounting plate 99 and into pressurized manifold 93. Seals 119 located at the entry point of piston 61 into manifold 93 allows for sliding movement of piston 61 while providing a barrier to pressurized air escaping from manifold 93.

A water level sensor 101 detects water level 103 and communicates the water level data to microprocessor 105. When water level 103 is at or below a designated height, microprocessor 105 signals water supply valve 107 to open allowing water to flow into manifold 93 from a water pressure supply 109. The water entering manifold 93 is distributed by plenum 111 to minimize turbulence of the entering water and to avoid splashing. The plenum can be, at times, above or below water level 103. Plenum 111 has slits or holes along the bottom to provide for relatively even, turbulent-free distribution of the entering water.

Pressurized air from a pressurized air source 113 is reduced to a desired pressure by regulator 115 or bleeding air from the tank by using a valve. Air hose 117 delivers the regulated pressurized air to manifold 93. The air overpressure in manifold 93 can be set as desired. However, lower air pressures are generably acceptable and are more convenient for sealing the manifold 93. Here pressures of less than 5 psig, and as low as 1 to 2 psig, have been found to be suitable.

An alternative method to pressurize the water vessel is to use a blower. The pressure is regulated by changing the speed of the internal valves, opening and closing louvers, changing the attack angle of the internal valves of the blower or bleeding the air from the pressure vessel by using a valve.

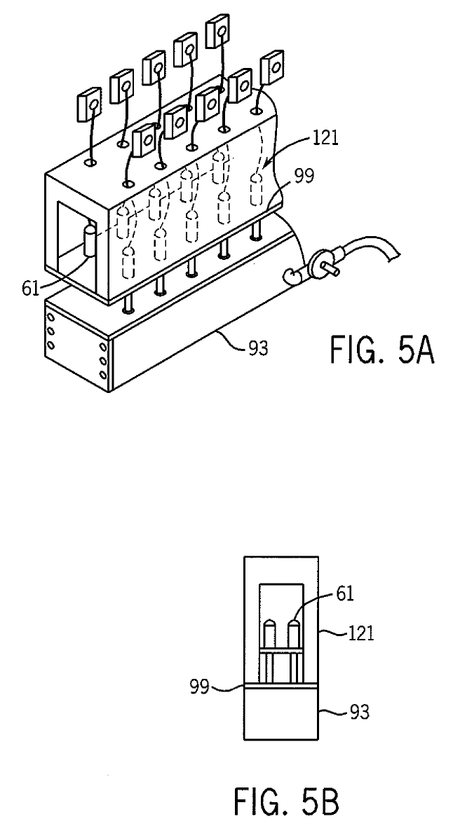

The operation of graphic waterfalls has inherently been noisy due to the action of numerous moving parts and the subsequent vibrations set up in the fountain itself. Experience shows that the noise problem can be exacerbated by use of the pneumatic driven pistons. Therefore, optional embodiments include the use of sound-absorbing enclosures as shown in FIGS. 5A and 5B and also in 6A and 6B. As shown in FIGS. 5A and 5B, piston 61 are mounted on mounting plate 99. For purposes of this embodiment, mounting plate 99 can be constructed of low-sound transmitting material. Preferably, this material is stiff like fiberglass or carbon, fiberboard or a rubber or some medium to high density normally limp that coats a metal 99. A sound-absorbent foam enclosure 121 is then mounting over the tops of piston 61 either on top of mounting plate 99 as shown on FIG. 5A or enclosing the exposed portions of piston 61 and mounting plate 99 as shown in FIG. 5B.

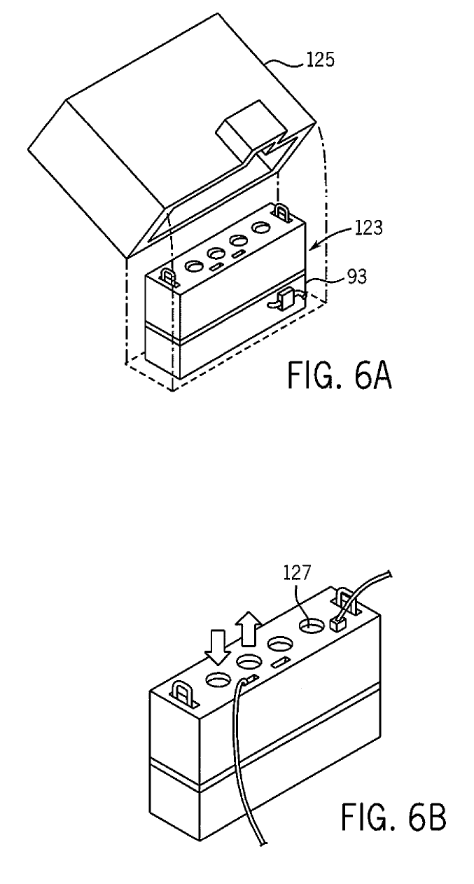

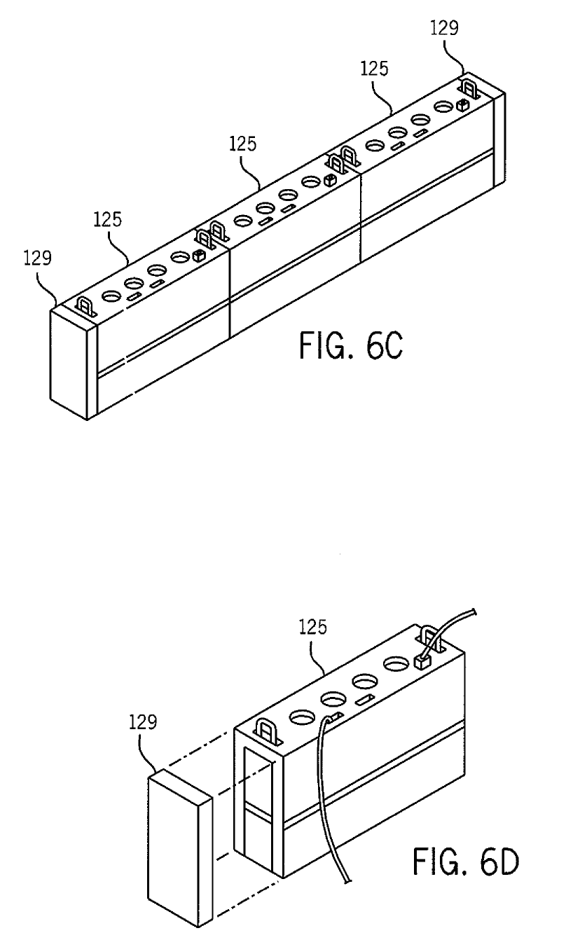

As shown in FIGS. 6A, B and D, another optional embodiment provides enclosure of even more parts of the graphical waterfall. FIG. 6A shows a modular valve body 123, which encases piston 61 (not shown) and mounting plate 99. Modular valve body 123 is attached to manifold 93. A foam jacket 125 is adapted to fully encase the assembly of modular valve body 123 and manifold 93. Foam jacket 125 is open on the bottom and covers the modular valve accepts the bottom where the water comes out of manifold 93. As shown in FIG. 6B, sound jacket 125 can have air vents 127 to allow for airflow in and out of foam jacket 125 thereby providing cooling of the parts contained within the foam jacket 125. This cooling is especially important in embodiments where electrical/mechanical synoides are used to drive piston 61. For larger fountains, multiple modular valve body 123 are assembled in connect series. They show in 6C multiple foam jackets 125 are mounted over the series of modular valve body 123. As illustrated in FIG. 6D, foam jackets 125 for a series array of modular valve bodies are also opened on each end to allow adjacent foam jackets 125 to abut each other. End caps 129 are mounted on the outside of the end modules when they are more than one module used.

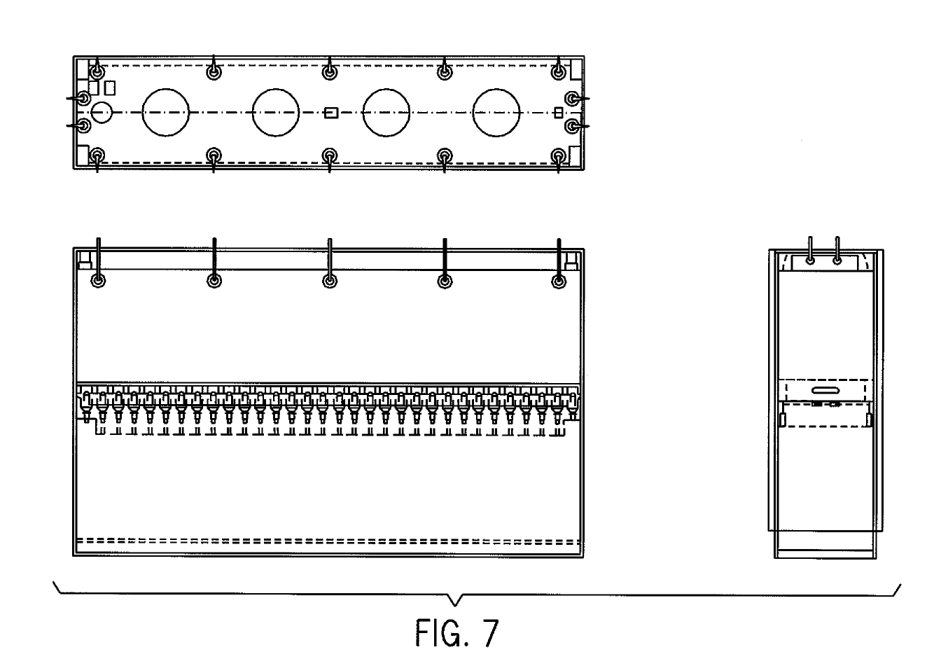

FIG. 7 shows an alternative sound enclosure for the module. The material is made from a limp and medium to high-density material like (rubber or foam) that covers 5 sides of the module. It serves to deaden the sound for both the pneumatic and electric-solenoid module. Rubber pads or rubber pads with a shock absorbing springs isolate the vibration of the module from the structure it rests on.

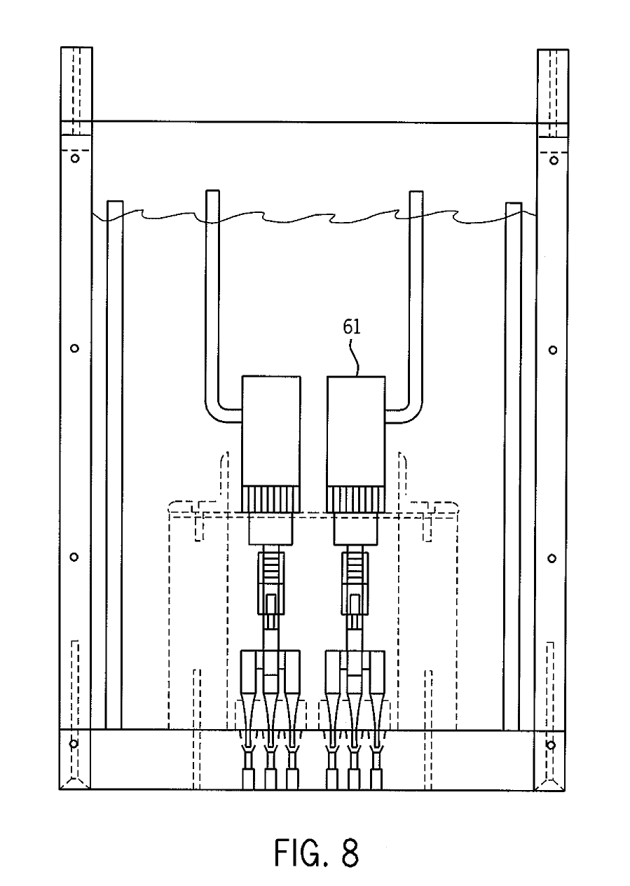

Another alternative to deadening the sound from the module is to submerge the assembly 61 in water. See FIG. 8. Although water has a faster sound transmission speed than air, the clattering of the valves are silenced but the resulting pulse from the escaping air results in a concussion to the tank sides. This is solved by lining the inside of the water tank with some dense material (like lead) or a limp material that is constructed in a way that results in an inner wall to the tank and is separate and independent to the outside wall. Air is evaluated from the cylinder in the tank by using tubes, whose ends extend above the water level surface.

In compliance with applicable statutes, the invention has been described in language more or less specific as to structural and methodical features. It is to be understood, however, that the invention is not limited to the specific features shown and described. The present invention has been described in terms of the preferred embodiment, and it is recognized that equivalents, alternatives, and modifications, aside from those expressly stated, are possible and within the scope of the appending claims.

What is claimed is:

1. A free falling water droplet fountain comprising a manifold having a series of openings, at least one control assembly for independently controlling the size and rate of release of water droplets from the openings, the controlling assembly including a plurality of pneumatically actuated valve assemblies for defining the form and size of the water droplets.

2. The fountain according to claim 1, wherein the valve assemblies each include a needle-like valve pintle and a resilient tubular member forming a reservoir for the water and having a central opening to define a valve seat for the pintle, the pintle being movable between open and closed positions relative to the valve seat to control the release of water droplets from the reservoir.

3. The fountain according to claim 2 wherein the valve assemblies include a tubular member positioned in each of the openings and a flange at the lower end of the member, the flange being set to a predetermined angular relation to the tubular member to define the formation of the water droplets.

4. The fountain of claim 1 wherein the control assembly further comprises at least one pneumatic solenoid.

5. The fountain according to claim 1, wherein the manifold is partially filled with a liquid and a head space is defined within the manifold above the water, the head space being maintained at a pressure above atmospheric pressure.

6. The fountain according to claim 1 including computer means for controlling the valve assemblies.

7. The fountain according to claim 1 further comprising means for abating sound produced by operation of the fountain.

8. A system for controlling droplet formation in a fountain, the system comprising: at least one pneumatic solenoid valve in fluid communication with a source of pressurized air;
at least one manifold having a series of openings; and,
at least one control assembly for independently controlling the size and rate of release of water droplets from the openings, the controlling assembly including a plurality of pneumatically actuated valve assemblies for defining the form and size of the water droplets,
wherein the valve assemblies are controlled between an open position and a closed position by selective actuation of the pneumatic solenoid.

9. The fountain according to claim 8, wherein the valve assemblies each include a needle-like valve pintle and a resilient tubular member forming a reservoir for the water and having a central opening to define a valve seat for the pintle, the pintle being movable between open and closed positions relative to the valve seat to control the release of water droplets from the reservoir.

10. The fountain according to claim 8 wherein the valve assemblies include a tubular member positioned in each of the openings and a flange at the lower end of the member, the flange being set to a predetermined angular relation to the tubular member to define the formation of the water droplets.

11. The fountain of claim 8 wherein the control assembly further comprises at least one pneumatic solenoid.

12. The fountain according to claim 8, wherein the manifold is partially filled with a liquid and a head space is defined within the manifold above the water, the head space being maintained at a pressure above atmospheric pressure.

13. The fountain according to claim 8 including computer means for controlling the valve assemblies.

14. The fountain according to claim 8 further comprising means for abating sound produced by operation of the fountain.
